(19) United States
(12) Patent Application Publication
(10) Pub. No.: US 2015/0068979 A1
(43) Pub. Date: Mar. 12, 2015

(54) HOLDER FOR MONOLITHIC SORBENTS

(71) Applicant: Merck Patent GmbH, Darmstadt (DE)

(72) Inventors: Karin Cabrera Perez, Dreieich (DE); Klaus Kreher, Muenster (DE); Willi Neuroth, Rossdorf (DE); Michael Ukelis, Riedstadt (DE)

(73) Assignee: Merck Patent GmbH, Darmstadt (DE)

(21) Appl. No.: 14/394,382

(22) PCT Filed: Mar. 22, 2013
(86) PCT No.: PCT/EP2013/000871

§ 371 Date: Oct. 14, 2014

(30) Foreign Application Priority Data
Apr. 14, 2012 (EP) 12002630.7

(51) Int. Cl. B01D 15/08

(52) U.S. Cl. CPC B01D 15/08
USPC 210/656; 210/198.2; 248/511

(57) ABSTRACT

The present invention relates to a holder for monolithic sorbents in which a radial pressure can be exerted over the entire length of the sorbent by a conically tapering clamping tube.

The present invention relates to a holder for monolithic sorbents in which a radial pressure can be exerted over the entire length of the sorbent by a conically tapering clamping tube.

For the production of conventional chromatography columns with particulate sorbents, the filling material is introduced into a stainless-steel or plastic tube with accurately fitting ends. This achieves that the sorbent bed lies in close contact with the column jacket and the sorbent particles are homogeneously distributed over the entire cross section of the column.

If, as disclosed, for example, in WO 94/19 687 and in WO 95/03 256, particulate sorbents are replaced by monolithic sorbents, the problem arises of sealing the sorbent cladding in a liquid-tight and pressure-stable manner. Inorganic or organic monolithic mouldings may shrink during production, meaning that they may not remain in the original shape in which they are produced. They must be provided with a new liquid-tight and pressure-stable cladding. Only so is it ensured that sample and eluent are transported exclusively through the sorbent.

Monolithic sorbents consist of a porous moulding, for example comprising silica gel, silica gel-containing materials or organic polymers. Various possibilities for the liquid-tight cladding of monolithic sorbents are disclosed in WO 98/59238, EP 1269179 and EP2118646. These include, for example, cladding with pressure-stable plastics, such as, for example, PEEK (polyether ether ketone) or fibre-reinforced PEEK.

Particularly good chromatographic properties are exhibited by monolithic sorbents having a bimodal pore system with macopores (through-pores) on the one hand and mesopores in the skeleton on the other hand. The macropore size determines the permeability or flow resistance and respectively the column back pressure. The mesopores serve for the provision of an increased surface area, which is necessary for the chromatographic separation process. Scientific studies have shown that the separation efficiency (N/m=number of trays/metres of column) is determined by the macropore size. It has been found that the separation efficiency comes out higher, the smaller the macropore is produced, for example a column having a macropore diameter of 2 μm has approximately an N/m=80,000 while a column having a macropore diameter of 1.1 μm has approximately an N/m=140,000. On the other hand, the macropore diameter also determines the column back pressure. A monolithic column having a column diameter of 4.6 mm and having a macropore diameter of 2 μm has a back pressure of about 25-30 bar at a flow rate of 2 ml/min (ACN/water; 60/40) while the column having the smaller macropores have a back pressure of about 50-70 bar under the same chromatographic conditions. The known PEEK or PPS claddings withstand a column back pressure of about 200 bar. Limitations in application therefore occur, in particular, in the case of columns of monolithic sorbents having relatively small macropores (and significantly higher separation efficiency) or also in the case of columns having relatively small diameters, since these columns exhibit relatively high column back pressures even in the lower flow-rate range.

In order also to be able to operate these columns with higher flow rates and more viscous mobile phases (for example MeOH/water; 50:50), a holder which presses the polymer cladding onto the column would be necessary. Otherwise, dead spaces in the form of gaps between sorbent and cladding arise at high column back pressures.

There are cartridge systems which are intended to increase the pressure resistance of the cladding. WO 98/59238 uses a steel tube into which a monolithic sorbent can be inserted. It is fixed by threaded joints at the ends. The disadvantage of this solution is that the fixing of the sorbent and the pressing arises via an axial pressure from the threaded joints at the ends.

More advantageous would be a radial pressing pressure which presses the cladding uniformly over the entire length. This is disclosed in DE 10030668, where a liquid or gas transmits the radial pressing pressure uniformly.

However, this design is very complex.

The object of the present invention was therefore to find a holder for monolithic sorbents which presses the cladding uniformly onto the sorbent, is simple to operate and can be re-used as easily as possible.

It has been found that a holder having a conically designed clamping tube can be employed in order to exert a uniform radial pressure on the column in a simple manner.

The present invention therefore relates to a holder for the accommodation of a monolithic chromatography column at least comprising
a clamping tube whose inside diameter is constant and whose outside diameter increases uniformly to a point between the two ends, to one end or to both ends and which has one or more slots in the longitudinal direction of the tube
a pressure sleeve consisting of a tube whose inside diameter increases uniformly from one end to the other end and which has at least one flange or groove on the outside
a clamping device

In a preferred embodiment, the clamping device consists of two screw parts whose inside diameter is greater than the outside diameter of the tube of the pressure sleeve, where one screw part has an external thread and one screw part has an internal thread, which can be screwed together.

In a preferred embodiment, the holder is made from stainless steel.

In a preferred embodiment, the outside diameter of the clamping tube increases towards the centre.

In a preferred embodiment, the holder has two pressure sleeves.

In a preferred embodiment, the clamping tube has 6 to 12 slots.

In a preferred embodiment, the slope of the surface shell of the clamping tube is between 1:60 and 1:40.

In a preferred embodiment, the clamping device is actuated mechanically, hydraulically, pneumatically or electromechanically. It is particularly preferably actuated mechanically.

The present invention also relates to a separating device at least consisting of a holder according to the invention and a monolithic chromatography column.

In a preferred embodiment, the monolithic chromatography column of the separating device has a PEEK or PPS cladding. The PEEK or PPS here may be fibre-reinforced with, for example, carbon or glass fibres or not.

In a preferred embodiment, the monolithic sorbent of the chromatography column has a diameter between 1 mm and 25 mm.

The present invention also relates to the use of a holder according to the invention or the separating device according to the invention for the chromatographic separation of at least two substances.

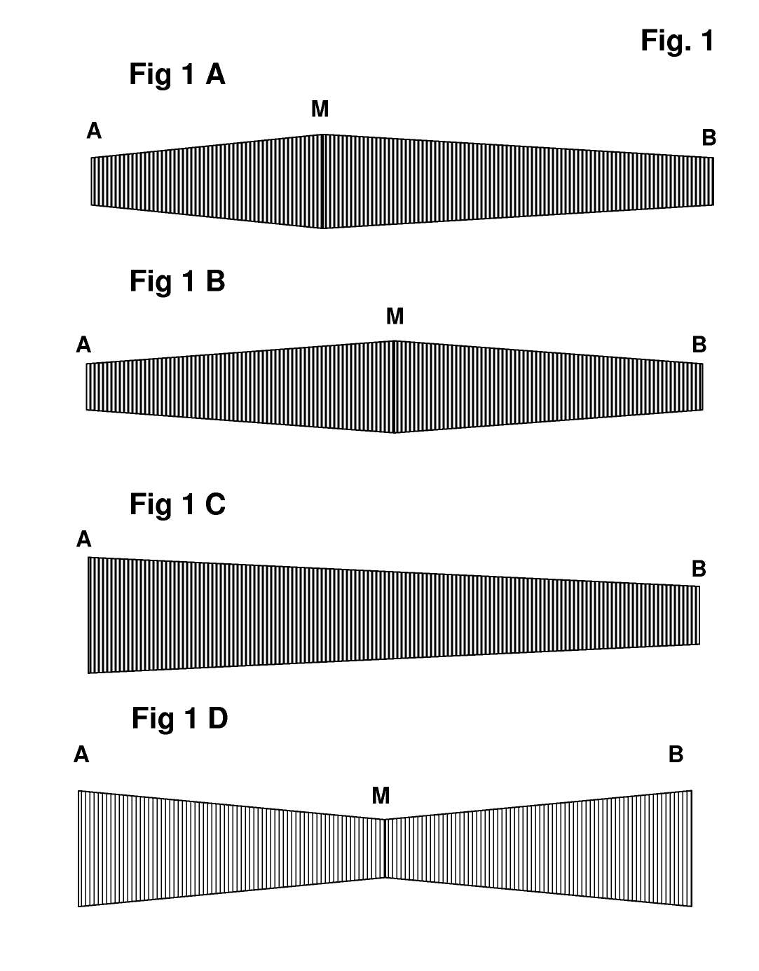

FIG. 1 shows a diagrammatically possible contours of clamping tubes.

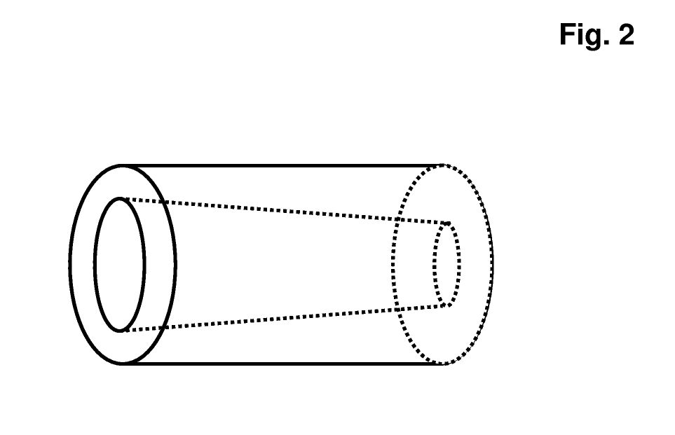

FIG. 2 shows diagrammatically a pressure sleeve (without flange or groove).

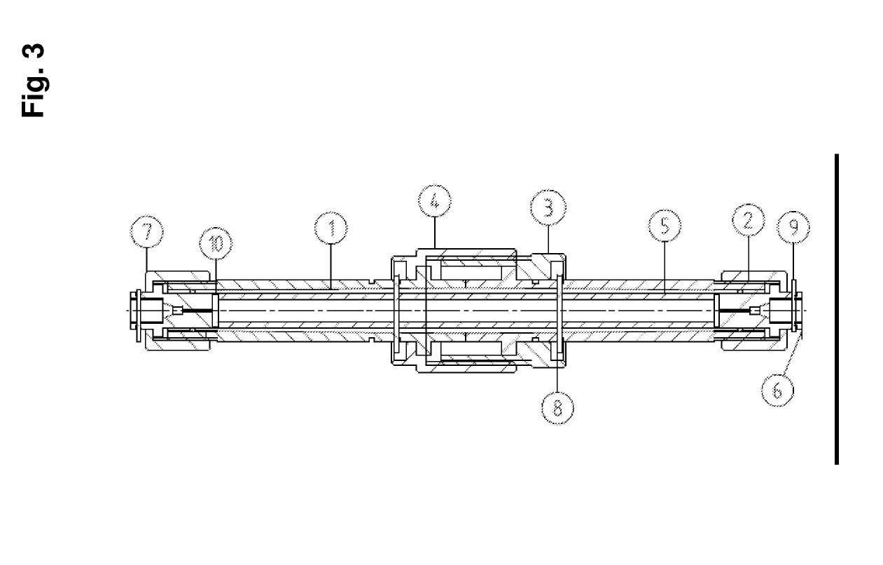

FIG. 3 shows a holder according to the invention with inserted chromatography column.

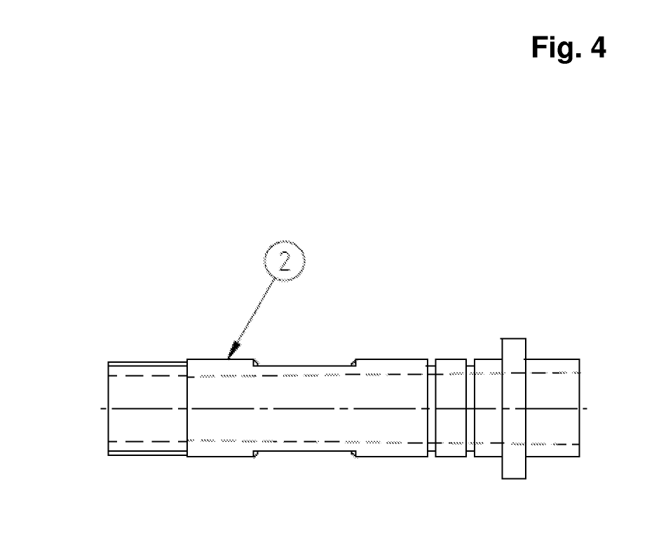

FIGS. 4 to 9 show the individual constituents of the holder according to the invention corresponding to FIG. 3. Further details on all drawings are given in the following text.

In accordance with the invention, a tube is an elongate hollow body whose length is generally essentially greater than its diameter. Tubes typically have a circular cross section, at least in the cavity. In accordance with the invention, tubes may consist of one workpiece or of two or more workpieces which can be joined together to form a tube. For example, a tube may in accordance with the invention also consist of two half-shells, which can be joined together to form a tube. The tubes employed in accordance with the invention, such as the clamping tube or the pressure sleeve, preferably consist of one workpiece.

The core of the holder according to the invention is the clamping tube. It is of such a nature that the monolithic column can be inserted into the clamping tube. It should preferably be possible to insert the monolithic column into the clamping tube with an accurate fit. This means that the insertion is possible without problems, but there is as little space as possible between the inside wall of the clamping tube and the chromatography column. The clamping tube may consist of one or more parts, which together form a tube. The clamping tube typically has at least the length of the monolithic sorbent for whose cladding it is intended. The clamping tube has a cavity having a circular cross section. The wall of the clamping tube typically also has a circular shape. The inside diameter of the clamping tube is the same over the entire tube length. This means that the clamping tube has a cylindrical cavity. The outside diameter of the clamping tube, by contrast, either increases uniformly from the two sides of the clamping tube to a point between the ends or it increases uniformly from one side of the clamping tube to the other or it increases uniformly from any desired point between the two ends towards the two ends. This increase in the outside diameter is typically achieved by the wall thickness of the clamping tube either increasing uniformly to a point between the ends or increasing uniformly from one side of the clamping tube to the other or increasing uniformly towards the two ends. Diagrammatic representations of the outside diameter of clamping tubes are shown in FIG. 1, where the increase in the outside diameter is depicted greater than typically necessary in order that it can be seen better on the drawings. In FIG. 1A, the outside diameter of the clamping tube increases from the two ends A and B to a point M which lies between the ends. It is closer to end A than to end B. The precise position of point M between the two ends is unimportant. It is typically closer to the centre of the tube than to one of the ends. In a preferred embodiment, the greatest outside diameter of the clamping tube is precisely in the centre between the two ends of the tube. This is depicted in FIG. 1B. In another embodiment, which is depicted in FIG. 1C, it increases from one end to the other, here from side B towards side A. In an embodiment depicted by way of example in FIG. 1D, the outside diameter increases uniformly from a point M between the two ends (in FIG. 1D from the centre of the tube) towards the two ends. The precise position of point M between the two ends is unimportant. It is typically closer to the centre of the tube than to one of the ends.

The increase in the diameter of the clamping tube can be represented via the slope of the surface shell of a right cone. The slope should be at least 1:75. It is typically not greater than 1:5. Preferred values are in the range between 1:60 and 1:40, particularly preferably about 1:50. This means that the diameter of the clamping tube particularly preferably increases by about 2 cm over a length of 50 cm (the diameter of a right cone is twice the radius of the cone at this point).

In addition, the clamping tube has at least one slot in the longitudinal direction of the tube. These slots may be run over the entire length of the tube, so that the tube is divided into two or more individual parts by the slots. In a preferred embodiment, the slots end before the two ends of the clamping tube, so that the tube remains closed at both ends and the clamping tube is thus in the form of one part. In accordance with the invention, a slot is an opening through the wall of the tube which runs in the longitudinal direction of the tube. This opening is designed in such a way that, if it is made from a one-part clamping tube without slots, not only takes place by cutting the wall of the clamping tube, but at the same time removal of material takes place. This means the slots in the wall of the clamping tube are not only elongated cracks, but also elongated holes, in the case of which a small part of the wall of the clamping tube has been removed compared with the wall of the clamping tube without slots. If the circular cross section of the clamping tube is considered, 5 to 15% of the cross section typically consists of slot, over the sum of all slots, and the remainder consists of wall. The clamping tube preferably has 6 to 12 slots.

It has been found that in this way a clamping tube arises which, due to its uniform inside diameter and the slots located in the tube wall, can be pressed uniformly and radially onto a monolithic sorbent located in the tube. Due to the slots, the inside diameter of the clamping tube can be matched accurately to the outside diameter of the sorbent. The pressing of the clamping tube onto the monolithic sorbent causes the slots to narrow, which results in a reduction in the clamping tube diameter. The clamping tube is consequently pressed onto the sorbent virtually over its entire wall cross section.

The clamping tube is typically pressed onto the sorbent by means of at least one pressure sleeve. A pressure sleeve consists of a tube whose inside diameter increases uniformly from one end to the other end and which has at least one flange or groove on the outside. In accordance with the invention, a flange denotes an annular thickening or a shoulder as well as thickenings having the same effect which are arranged in annular form around the pressure sleeve, for example in the form of individual nubs. The flange is preferably worked integrally with the pressure sleeve, but may also be subsequently stuck on, screwed or attached to the pressure sleeve in another manner. A groove is in accordance with the invention a recess running in annular form around the pressure sleeve or a plurality of individual recesses running in a ring around the pressure sleeve, on which, for example, two half-shells can be placed.

(The diagrammatic representation of a pressure sleeve for illustration of the increasing inside diameter can be found in FIG. 2. For simplification, a flange or groove is not also depicted here. FIG. 4 shows a possible embodiment of a pressure sleeve with flange/groove.

The inside diameter of the pressure sleeve is designed to match the outside diameter of the clamping tube. The length of the pressure sleeves is unimportant. The one or more pressure sleeve used should preferably cover the entire length of the clamping tube. In this way, ideal pressure transmission to the clamping column is ensured. In an embodiment, the pressure sleeves project on both sides of the clamping tube, so that column end pieces with filters, pre-columns, perforated plates or the like can be connected to the pressure sleeves. End pieces of this type correspond to the usual end pieces for chromatography columns and are known to the person skilled in the art. For example, the pressure sleeves may be provided with corresponding internal or external threads for the connection of the end pieces. The pressure sleeves may equally be provided with threads or plug-type devices for the connection of the solvent feed and outlet.

In a preferred embodiment, two pressure sleeves are employed, which are pushed from both sides onto a clamping tube whose outside diameter increases towards the centre. Due to the conical shape of the clamping tube and the conical shape of the inside hole of the pressure sleeves, the pressure sleeves can be pushed onto the clamping tube, where, in the case of accurate manufacture of the parts, contact takes place between the inside wall of the pressure sleeve and the outside wall of the clamping tube which is not only localised , but instead takes place over the length and cross section of the clamping tube.

If the pressure sleeves are now pushed further onto the clamping tube with greater force, the radial pressure of the inside wall of the pressure sleeve on the clamping tube increases. This compresses the clamping tube radially, and the slots in the clamping tube become smaller. This in turn reduces the inside diameter of the clamping tube, which results in an increased radial pressure on a monolithic column located in the clamping tube. In this way, the radial pressure of the clamping tube on the monolithic column can be regulated via the force with which the pressure sleeve or the pressure sleeves are pushed onto the clamping tube.

The pressure sleeves preferably have an external flange. A screw device via which the pushing of the pressure sleeves onto the clamping tube is regulated is placed on the external flange of the pressure sleeves.

In a preferred embodiment, the screw device consists of two screw parts, one of which has an internal thread and one of which has an external thread, which can be screwed together. The screw parts are ring-shaped and can be pushed from both sides over the pressure sleeve or the pressure sleeves until they hit a fixing. This fixing is typically a mechanical barrier in the form of a flange on the pressure sleeve, or a shoulder or ring introduced into a groove of the pressure sleeve, typically in the form of half-shells.

If only one pressure sleeve is used, a screw part is pushed onto the pressure sleeve as far as a flange or shoulder. The other screw part is inverted over the free end of the clamping tube and is narrowed at one end in such a way that it cannot be pushed completely over the clamping tube but instead is fixed at its end. The length of the screw parts is matched to the length of the pressure sleeve and the separation between the flange of the pressure sleeve and the end of the clamping tube in such a way that the screw part lying against the flange can be screwed to the screw part lying against the end of the clamping tube. The further the two screw parts are screwed together, the further the pressure sleeve is pulled onto the clamping tube and the greater the radial pressure of the pressure sleeve on the clamping tube.

In a preferred embodiment, two pressure sleeves are used, each of which has a flange or shoulder or a corresponding fixing. In this case, the screw device consists of two screw parts, one of which has an internal thread and one of which has an external thread, which can be screwed together. The screw parts are ring-shaped and can be pushed over the pressure sleeves from both sides until they come up against the fixing. The length of the screw parts is matched to the separation between the fixings on the two pressure sleeves in such a way that the two screw parts can be screwed together.

The further the two screw parts are screwed together, the further the two pressure sleeves are pulled onto the clamping tube towards the centre and the greater the radial pressure of the pressure sleeves on the clamping tube.

Instead of two screw parts, the screw device may also consist of other means by means of which the pressure sleeves can be pressed further onto the clamping tube. For example, instead of the screw parts, two perforated plates can be fixed from both sides, which can then be connected by means of a plurality of tension screws and pressed together. Alternative embodiments use hydraulic, pneumatic or electromechanical devices by means of which the pressure sleeves can be pressed further onto the clamping tube.

FIG. 3 shows a preferred embodiment of the holder into which the chromatography column is incorporated. The clad chromatography column (5) is introduced into the clamping tube (1). The inside diameter of the clamping tube (1) here is selected so that the chromatography column (5) can be inserted with an accurate fit. The outside diameter of the clamping tube (1) increases towards the centre. Two pressure sleeves (2) are pushed onto the clamping tube (1). The pressure sleeves are pushed together towards the centre of the clamping tube by two screw parts (3) and (4), which act on the groove of the two pressure sleeves, so that radial pressure is exerted on the clamping tube. Screw part (3) has an external thread and screw part (4) has an internal thread, so that the two screw parts can be screwed together.

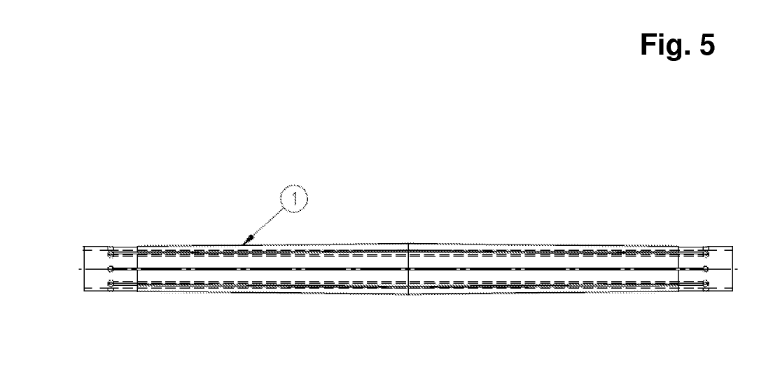

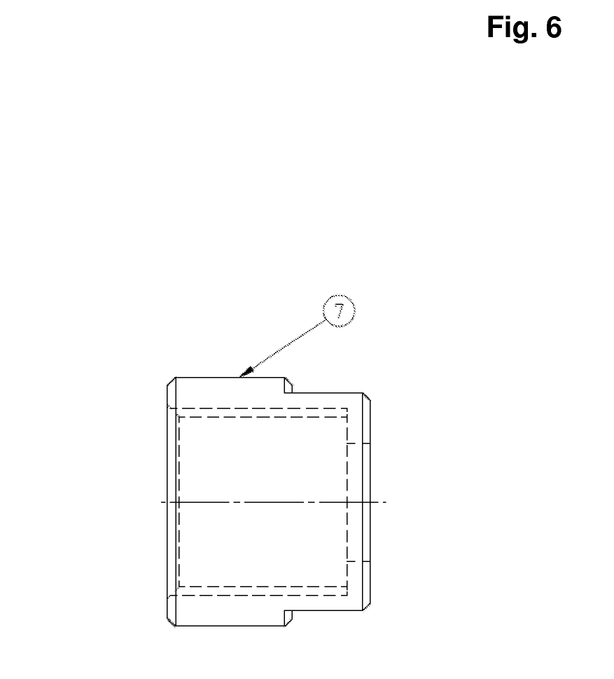

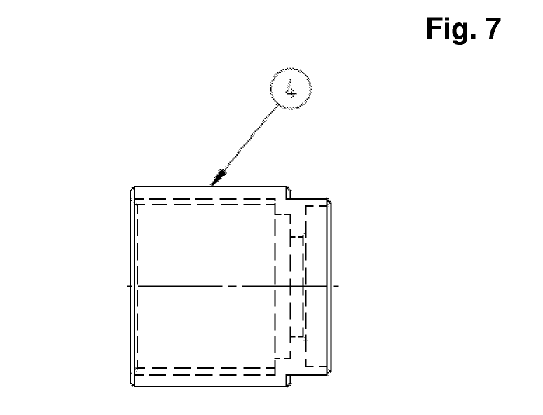

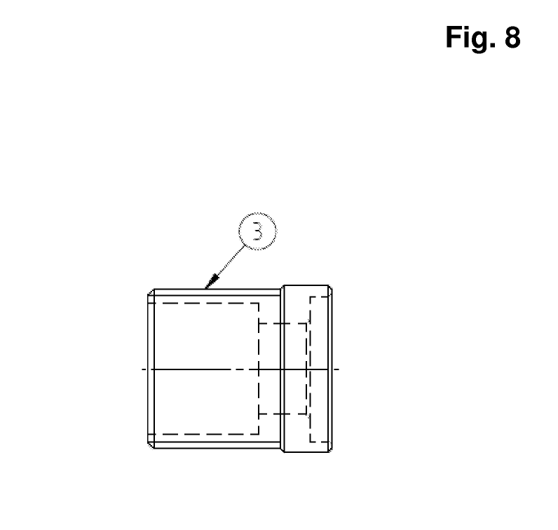

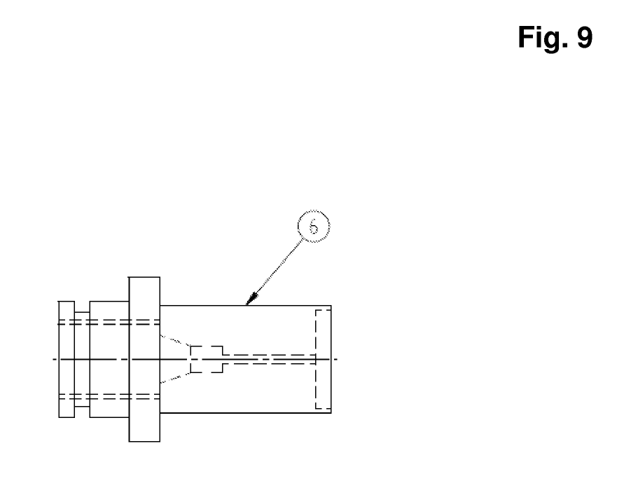

An end threaded joint (7), which is screwed onto the pressure sleeves (2), is installed on both ends of the holder. This end threaded joint serves for the connection of solvent feed and outlet. In this case, the connection consists of a capillary connection (6), which is also used in conventional chromatography columns. Perforated plate 10 serves for better distribution of the liquid on the sorbent. Safety ring 8 and safety disc 9 are assembly aids. FIGS. 4 to 9 again depict individually the constituents of the holder according to the invention. FIG. 4 shows a pressure sleeve (2), FIG. 5 shows the clamping tube (1), FIG. 6 shows the end threaded joint (7), FIG. 7 shows the screw part with internal thread (4), FIG. 8 shows the screw part with external thread (3) and FIG. 9 shows the capillary connection (6).

All constituents of the holder according to the invention can consist of metal, for example stainless steel, or mechanically stable, optionally fibre-reinforced plastics, such as PEEK (polyether ether ketone), PPS (polypropylene sulfide), POM (polyoxymethylene) or PVDF (polyvinyl fluorides). It is also possible for different parts of the holder to consist of different materials. The clamping tube, the pressure sleeves and the screw device preferably consist of stainless steel.

The present invention also relates to the use of the holder according to the invention for the pressure-stable cladding of monolithic chromatography columns and to monolithic chromatography columns clad with the holder according to the invention.

The present invention also relates to a separating device consisting of the holder according to the invention and a monolithic chromatography column introduced into the holder.

The holder according to the invention is suitable for any type of monolithic chromatography columns.

A monolithic chromatography column, also called monolithic column, consists at least of a monolithic sorbent and a cladding.

Monolithic sorbents are known to the person skilled in the art.

Monolithic sorbents for chromatography consist of a porous moulding, for example comprising silica or organic polymers. The porous moulding has at least through-pores. Preference is given to monolithic mouldings comprising silica or silica-containing materials which have a bimodal pore system with macopores or through-pores on the one hand and mesopores in the silica-gel skeleton on the other hand. The macropore size determines the permeability and respectively the column back pressure. The mesopores serve for the provision of an increased surface area, which is necessary for the chromatographic separation process.

The monolithic columns are usually clad with polymers, such as, for example, PEEK or PPS, in order to be able to be employed in chromatography.

For use in the holder according to the invention, the monolithic sorbents must not be clad in a pressure-stable manner. However, they must have a liquid-tight cladding. This can be, for example, a shrink tube comprising a solvent-stable plastic. Equally, the sorbents may be provided with a conventional cladding of polymers, such as, for example, PEEK or PPS. The monolithic sorbents in the holder according to the invention are preferably clad with a solvent-stable cladding of plastics, such as PEEK or PPS. The cladding may also be fibre-reinforced. Such claddings of the commercially available monolithic sorbents are known to the person skilled in the art. An example thereof are the fibre-reinforced PEEK- or PPS-clad Chromolith® columns from Merck KGaA, Germany.

Further suitable materials and methods for the cladding of monolithic sorbents can be found in EP 1269179 and EP 2118646.

The advantage of a solvent-stable cladding of the sorbents which is also pressure-stable, at least at a low column back pressure up to 200 bar, in the holder according to the invention consists in that the transmission of the radial pressure exerted by the holder to the sorbent via a uniform cladding which is also pressure-stable at a low column back pressure takes place more uniformly and effectively than, for example, in the case of a thin shrink tube.

For connection to a chromatography system, the device according to the invention typically has suitable end pieces. These correspond to the end pieces which facilitate solvent feed and outlet that are typically used in chromatography columns. They can be attached to the column itself, the clamping tube or preferably to the pressure sleeves, for example via an end threaded joint.

The holder according to the invention is very stable, easy to use and can be re-used. The holder can be adapted to any column diameter through the choice of the inside diameter of the clamping tube. Typical diameters of monolithic chromatography columns are between 1 mm and 25 mm, preferred diameters are between 1 mm and 10 mm.

Even without further comments, it will be assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application EP 12002630.7, filed on Apr. 14, 2012, is incorporated into this application by way of reference.

### Examples

A PEEK-clad monolithic sorbent (Chromolith®, silica gel, diameter 4.6 mm, bimodal pore system with macorpores of about 1.1 μm and mesopores of 15 nm)) is placed in the holder according to the invention in accordance with FIG. 3 and chromatographed with a flow rate of 2 ml/min (ACN/water; 60:40 v/v). A column back pressure of 95 bar is measured here. The flow rate is subsequently increased to 6 ml/min, the chromatographic analysis becomes faster by a factor of 3, and a back pressure of 298 bar is measured. In order to test the holder at an even higher operating pressure, the eluent system is changed to 2-propanol/water (50:50 v/v) and chromatographed with a flow rate of 1.8 ml/min. A column back pressure of 340 bar is measured here. The system does not leak, and a suitable chromatogram is obtained under all conditions mentioned.

1. Holder for the accommodation of a monolithic chromatography column at least comprising
a clamping tube whose inside diameter is constant and whose outside diameter increases uniformly towards the centre, to one end or to both ends and which has one or more slots in the longitudinal direction of the tube
a pressure sleeve consisting of a tube whose inside diameter increases uniformly from one end to the other end and which has at least one flange or groove on the outside
a clamping device

2. Holder according to claim 1, characterised in that the clamping device consists of two screw parts whose inside diameter is greater than the outside diameter of the tube of the pressure sleeve, where one screw part has an external thread and one screw part has an internal thread, which can be screwed together.

3. Holder according to claim 1, characterised in that the holder is made from stainless steel.

4. Holder according to claim 1, characterised in that the outside diameter of the clamping tube increases towards the centre.

5. Holder according to claim 1, characterised in that the holder has two pressure sleeves.

6. Holder according to claim 1, characterised in that the clamping tube has 6 to 12 slots.

7. Holder according to claim 1, characterised in that the slope of the surface shell of the clamping tube is between 1:60 and 1:40.

8. Holder according to claim 1, characterised in that the clamping device is actuated mechanically, hydraulically, pneumatically or electromechanically.

9. Separating device at least consisting of a holder according claim 1 and a monolithic chromatography column.

10. Separating device according to claim 9, characterised in that the monolithic chromatography column has a PEEK or PPS cladding.

11. Separating device according to claim 9, characterised in that the monolithic sorbent of the chromatography column has a diameter between 1 mm and 25 mm.

12. A process for the chromatographic separation of at least two substances comprising subjecting said substances to a separating device according to claim 9.
